(19) United States
(12) Patent Application Publication
(10) Pub. No.: US 2008/0144310 A1
(43) Pub. Date: Jun. 19, 2008

(54) Rechargeable lighting apparatus

(76) Inventors: Stefane Barbeau, Roxbury, MA (US); Duane Smith, Roxbury, MA (US); Daniel Reilly, Dedham, MA (US)

Correspondence Address: SEYFARTH SHAW LLP, 131 S. DEARBORN ST., SUITE 2400, CHICAGO, IL, 60603-5803, US

(21) Appl. No.: 11/891,341

(22) Filed: Aug. 10, 2007

Related U.S. Application Data
(63) Continuation-in-part of application No. 29/264,500, filed on Aug. 11, 2006, now Pat. No. D557450.
Application No. 29/264,500 is a continuation-in-part of application No. 29/264,509, filed on Aug. 11, 2006, now Pat. No. D546495.
Application No. 29/264,509 is a continuation-in-part of application No. 11/460,512, filed on Jul. 27, 2006.
Application No. 11/460,512 is a continuation-in-part of application No. 11/161,689, filed on Aug. 12, 2005.
Application No. 11/161,689 is a continuation-in-part of application No. 10/989,199, filed on Nov. 15, 2004.
Application No. 10/989,199 is a continuation-in-part of application No. 10/292,007, filed on Nov. 9, 2002, now Pat. No. 6,819,080.
Application No. 10/292,007 is a continuation-in-part of application No. 09/885,848, filed on Jun. 20, 2001, now Pat. No. 6,479,965.
(60) Provisional application No. 60/837,062, filed on Aug. 11, 2006.

(51) Int. Cl. F21L 4/00; H02J 7/00

(52) U.S. Cl. 362/183; 320/114

(57) ABSTRACT

A lighting apparatus usable for providing light or illumination is provided. The lighting apparatus is formed of components or modules that are easily interchanged to allow uniform parts, simple assembly, and selection of desired features for a particular lighting device.

### CROSS-REFERENCE TO RELATED APPLICATIONS

This claims the benefit of Provisional Application No. 60/837,062, filed Aug. 11, 2007, is a continuation-in-part of application Ser. Nos. 29/264,500, filed Aug. 11, 2006, and 29/264,509, filed Aug. 11, 2006, and is a continuation-in-part of application Ser. No. 11/460,512, filed Jul. 27, 2006, which is a continuation-in-part of application Ser. No. 11/161,689, filed Aug. 12, 2005, which is a continuation-in-part of application Ser. No. 10/989,199, filed Nov. 15, 2004, which is a continuation-in-part of application Ser. No. 10/292,007, filed Nov. 9, 2002, now U.S. Pat. No. 6,819,080, which is a continuation-in-part of application Ser. No. 09/885,848, now U.S. Pat. No. 6,479,965, the specifications of each being incorporated herein by reference in their entirety.

### FIELD OF THE INVENTION

The invention relates to the field of illumination and, in particular, to a rechargeable lighting apparatus.

### BACKGROUND

Currently, many lighting devices including flashlights and lamps are assembled so that only certain aspects may be readily changed by a consumer. For instance, other than changing light bulbs or other light emitters and/or batteries, if present, the lighting devices permit little if any modification to suit a consumer's tastes.

Accordingly, there has been a need for an improved lighting device.

### SUMMARY

In accordance with an aspect of the present invention, a lighting apparatus usable for providing light or illumination is provided. The lighting apparatus is formed of components or modules that are easily interchanged to allow uniform parts, simple assembly, and selection of desired features for a particular lighting device.

### BRIEF DESCRIPTION OF THE DRAWINGS

FIG. 1 is a perspective view of a lighting device of the present invention including a first form of an external diffuser;

FIG. 2 is a perspective view corresponding to FIG. 1 with the external diffuser thereof shown in half-tone;

FIG. 3 is a perspective view of the lighting device of FIG. 1 with a second form of an external diffuser;

FIG. 4 is a perspective view corresponding to FIG. 3 with the external diffuser thereof shown in half-tone;

FIG. 5 is a first exploded perspective view of the lighting device and external diffuser of FIG. 1;

FIG. 6 is a second exploded perspective view of the lighting device and external diffuser of FIG. 1;

FIG. 7 is an exploded view of a first side of the lighting device and external diffuser of FIG. 1;

FIG. 8 is an exploded view corresponding to FIG. 7 showing a second side;

FIG. 9 is an exploded side elevational view of the lighting device;

FIG. 10 is a first exploded perspective view of the lighting device;

FIG. 11 is a first enlarged exploded detail view of portions of the lighting device;

FIG. 12 is a second enlarged exploded detail view of portions of the lighting device;

FIG. 13 is an enlarged exploded perspective view of portions of the lighting device and a lower end of the external diffuser of FIG. 1;

FIG. 14 is a perspective view similar to FIG. 10 with a base cover and a power module removed;

FIG. 15 is a bottom plan view of the lighting device showing the base cover;

FIG. 16 is a top plan view of the base cover;

FIG. 17 is a top plan view of a support base received by the base cover;

FIG. 18 is a bottom plan view of the support base of FIG. 17;

FIG. 19 is a top perspective view of the power module;

FIG. 20 is a bottom plan view of the power module of FIG. 19;

FIG. 21 is a side elevation view of a first side of an internal diffuser of the lighting device of FIG. 1;

FIG. 22 is a side elevation view similar to FIG. 21 showing a second side of the internal diffuser;

FIGS. 23-25 are bottom perspective views of the internal diffuser of FIG. 21;

FIG. 26 is a bottom plan view of the internal diffuser of FIG. 21;

FIG. 27 is a perspective view of a circuit board and light emitters carried thereon of the lighting device;

FIG. 28 is a half-tone image of top portions of a pair of the external diffusers of FIG. 1;

FIG. 29 is a half-tone image of a pair of lighting devices assembled with the bottom portions of a pair of the external diffusers of FIG. 1;

FIG. 30 is a half-tone image of a plurality of lighting devices assembled with the external diffusers of FIG. 3;

FIG. 31 is a half-tone image of the internal diffuser positioned above other portions of the lighting device;

FIG. 32 is a half-tone image of the assembled lighting device; and

FIG. 33 is a half-tone image of the assembled lighting device when illuminated.

### DETAILED DESCRIPTION

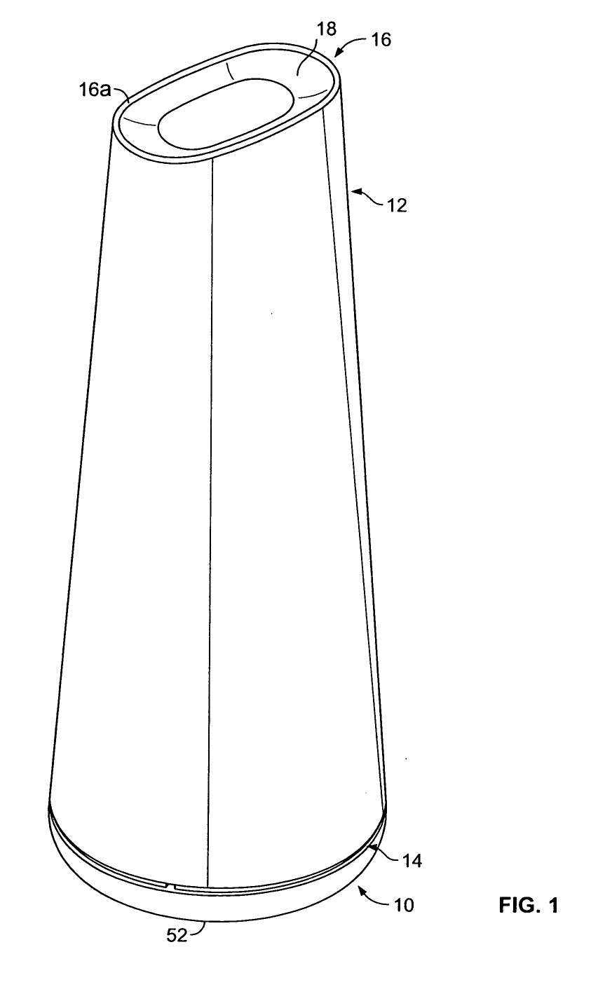

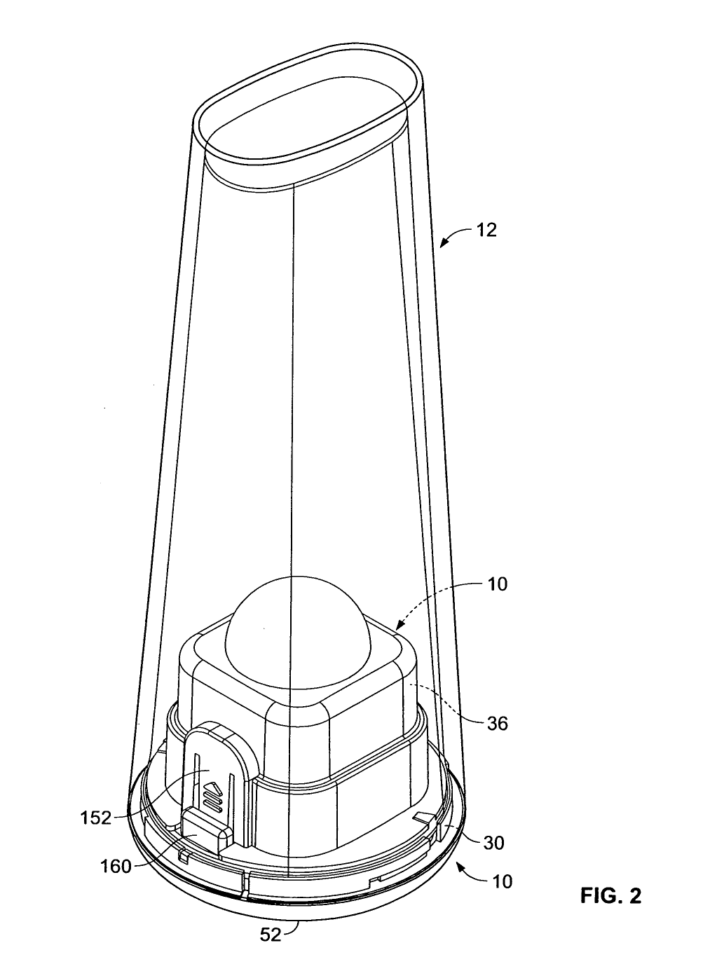

Referring initially to FIGS. 1-2, a lighting device 10 supporting an external diffuser 12 is shown. The external diffuser 12 is sheath-like and is a generally a translucent, semi-transparent, or semi-opaque material that permits light produced by the lighting device 10 in an internal cavity of the external diffuser 12 to pass through and outward from the external diffuser 12. In FIGS. 1 and 2, the external diffuser 12 is an elongated member, preferably of injection or blow-molded plastic or polymeric material, that is removably connected to the lighting device 10. The external diffuser 12 has a lower end 14 that has a circular shape and secures with the lighting device 10 about a circular portion thereof, as will be discussed in greater detail below. The external diffuser 12 tapers inwardly from the lower end 14 towards an upper end 16. At an uppermost portion 16a, the external diffuser 12 has an oval-shape such that the tapering of the external diffuser 12 is greater along two opposed sides than the tapering of the sides intermediate thereof. The external diffuser 12 has a top surface 18 that is presently concave, though it may be flat or convex as well.

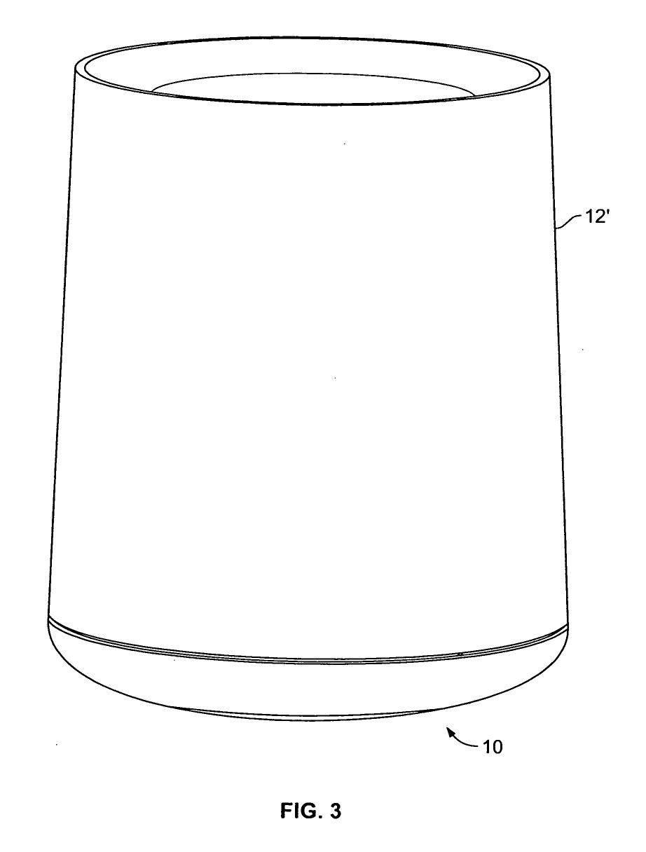

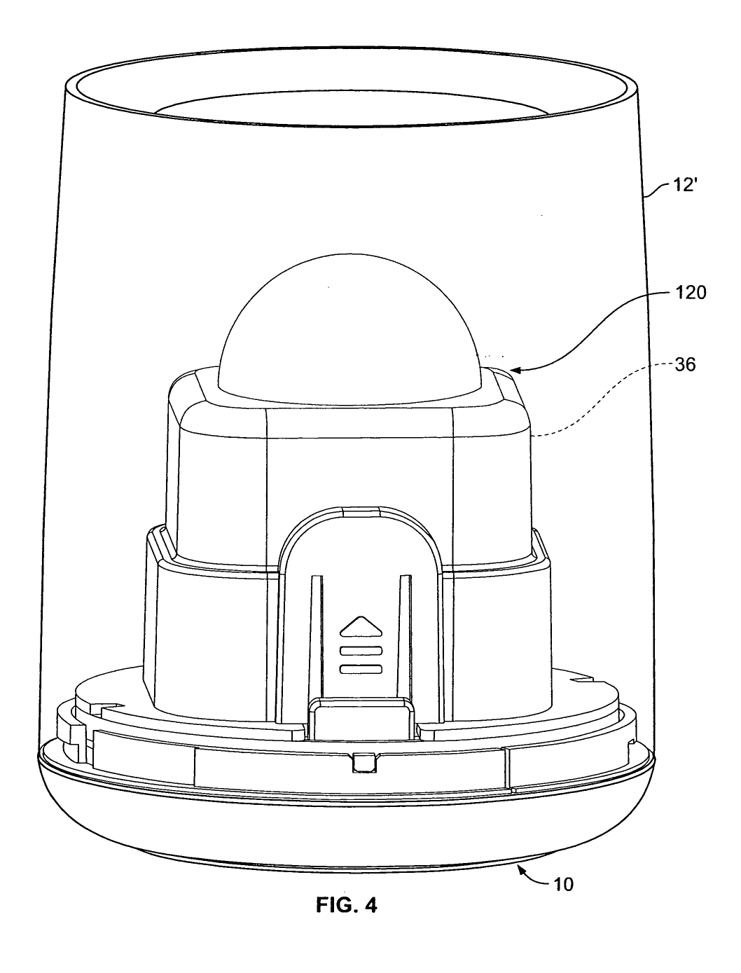

In comparing FIGS. 1-2 with FIGS. 3-4, a second form of an external diffuser 12′ is shown. The external diffuser 12′ is shorter in height than, though has a similar shape to, the external diffuser 12. More specifically, the external diffuser 12′ of FIGS. 3-4 is a truncated from of the external diffuser 12 of FIGS. 1-2 so that the sides taper inward from a bottom portion that connects with the lighting device 10 towards a top portion, the top portion also being preferably concave.

As can be seen in FIGS. 2 and 4, the lighting device 10 is substantially, though not entirely, located within the external diffusers 12 and 12′. The lighting device 10 itself may be considered a module, and indeed is handled and assembled with the diffuser 12 as a single module. However, the lighting device 10 itself is assembled as modules or components that are easily separated to allow a user to modify the lighting device 10.

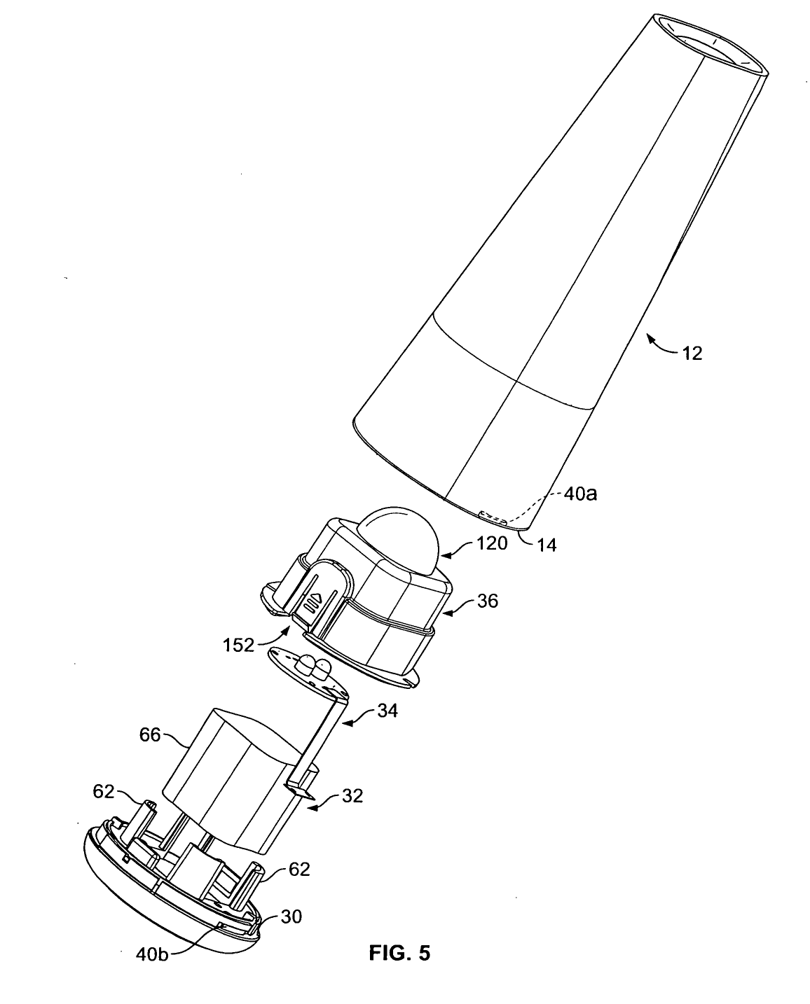

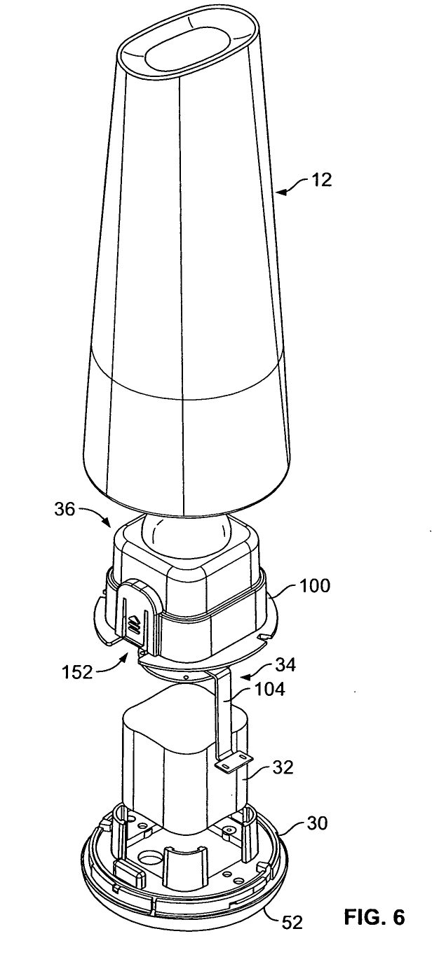

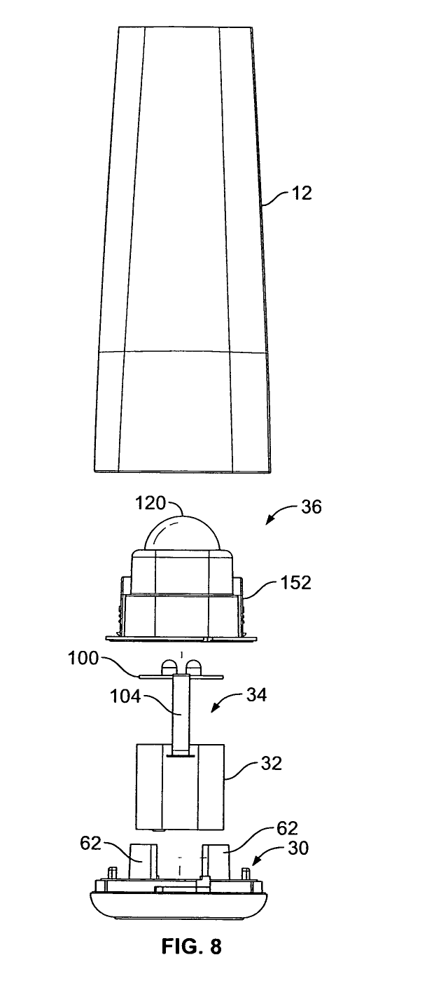

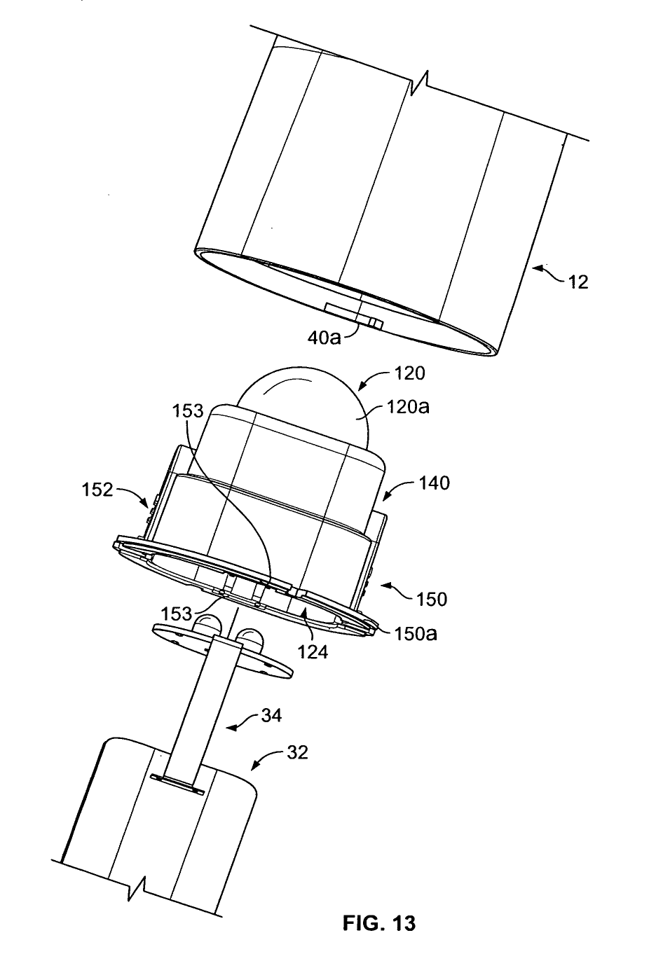

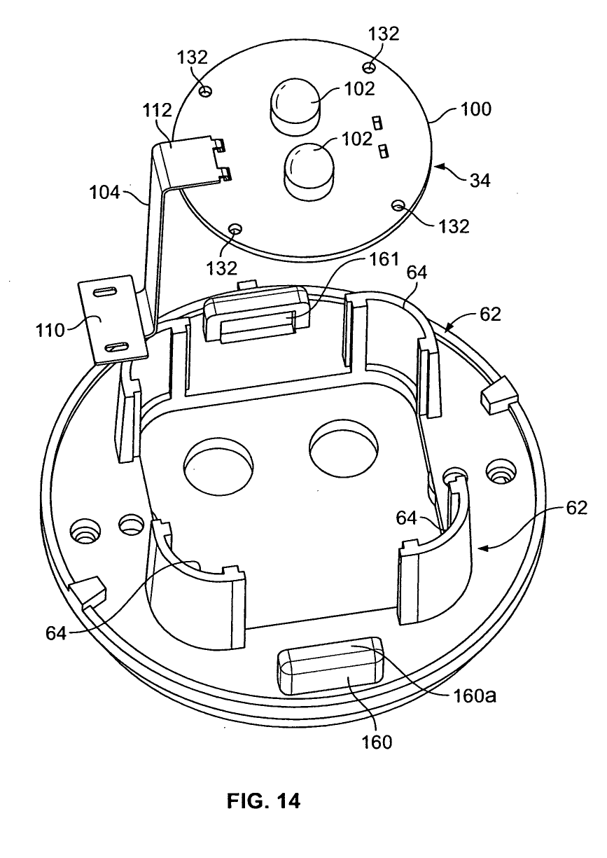

With reference to FIGS. 5-8, the lighting device 10 includes a support base 30, a battery or power module 32 supported by the support base 30, a circuit module 34, and an internal diffuser module 36 that secures the battery 32 and circuit module 34 with the support base 30. The external diffuser 12 is then secured with the lighting device 10 so that the battery 32, the circuit module 34, and the internal diffuser 36 are positioned within the external diffuser 12. Towards this end, the support base 30 and external diffuser lower end 14 include cooperating engagement structure 40a and 40b, preferably a quick-connect or quick-release connection that allows the external diffuser 12 to easily be secured with the support base 30, such as with a quart or eighth of a turn of the external diffuser 12 relative to the support base 30, best seen in FIGS. 10 and 13.

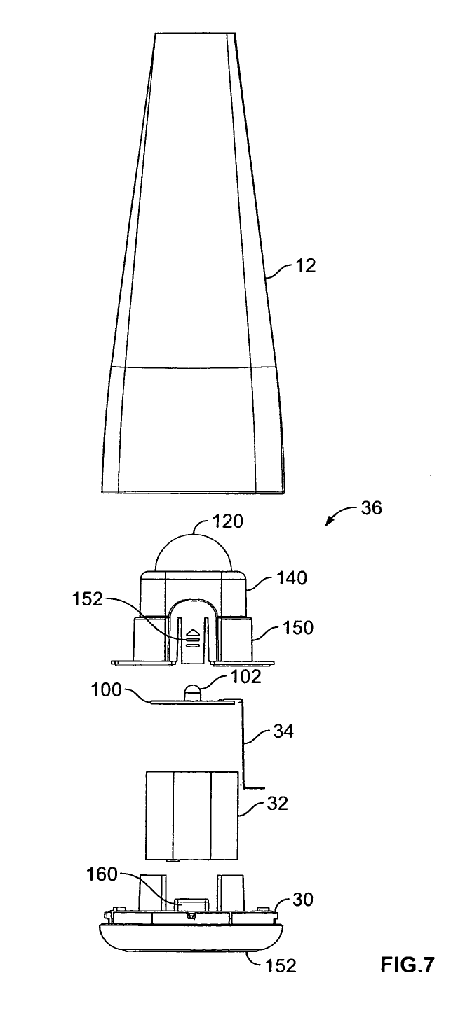

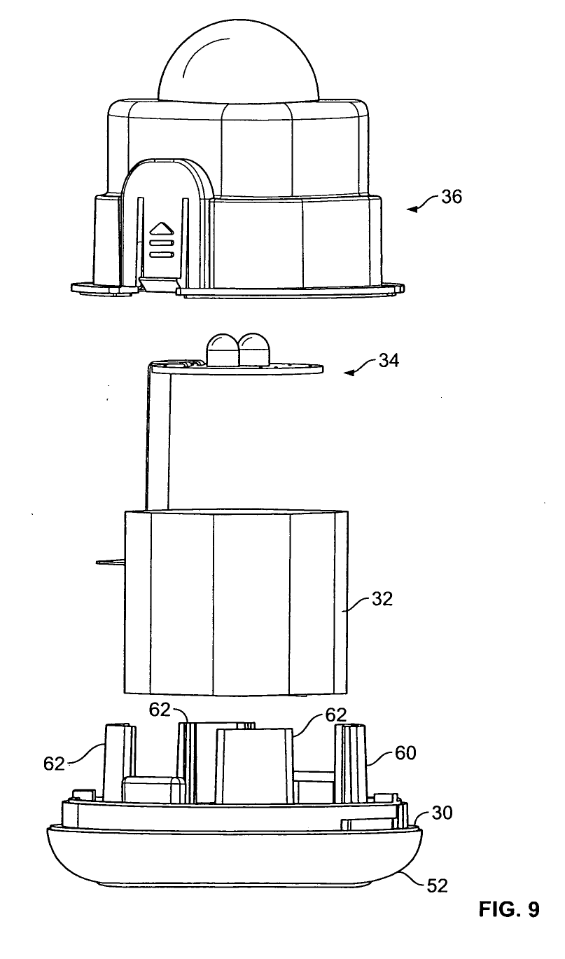

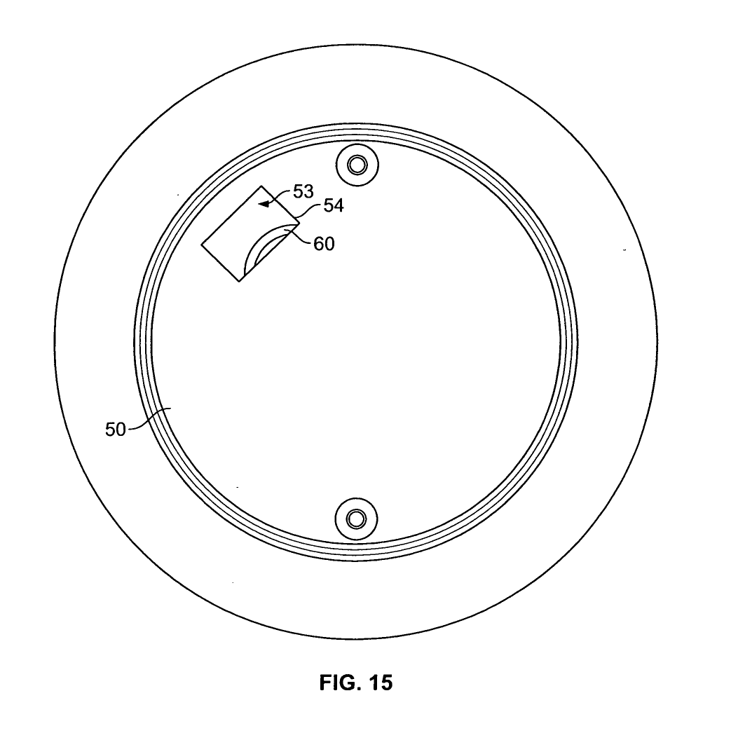

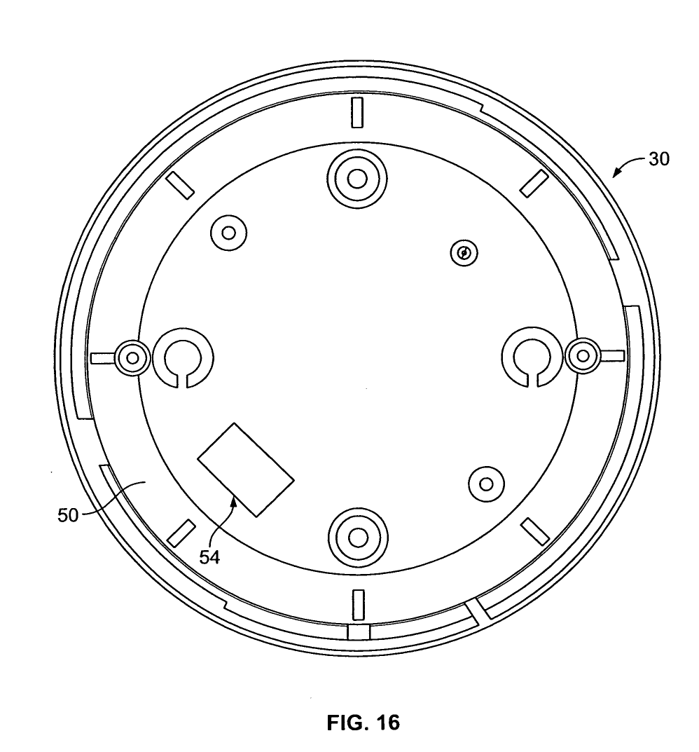

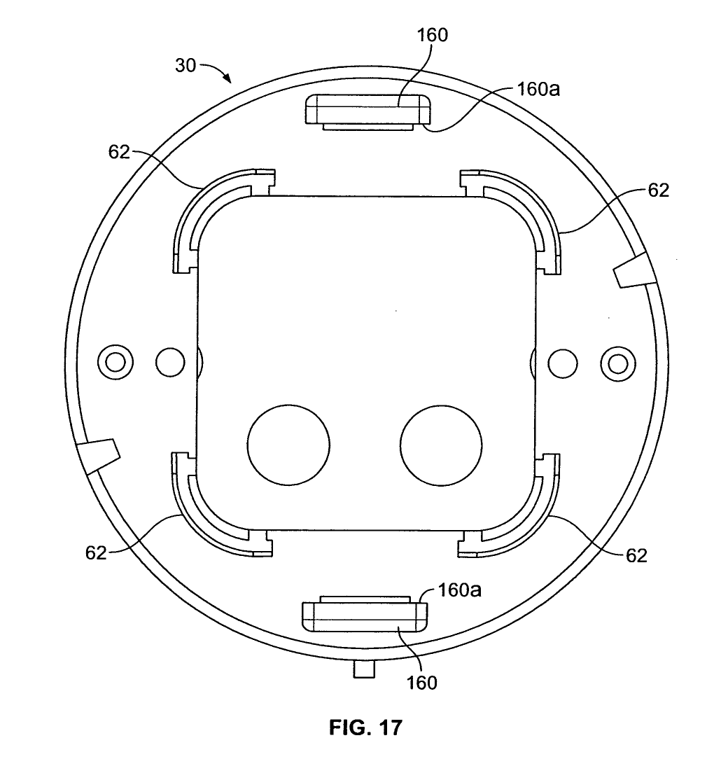

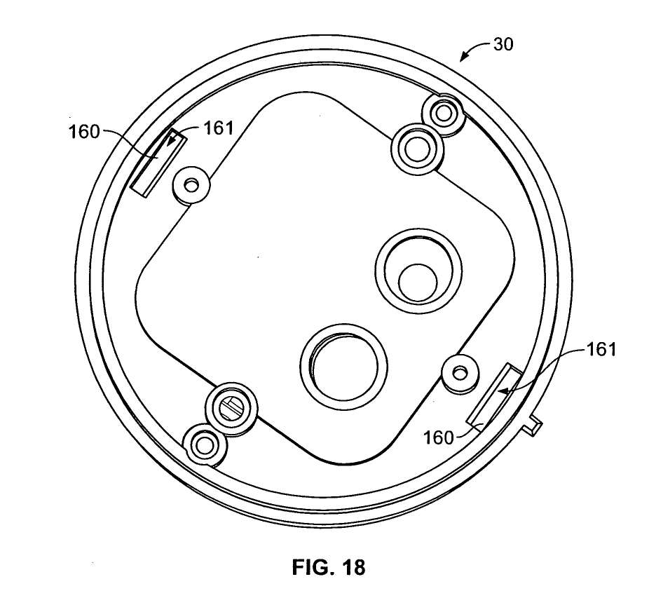

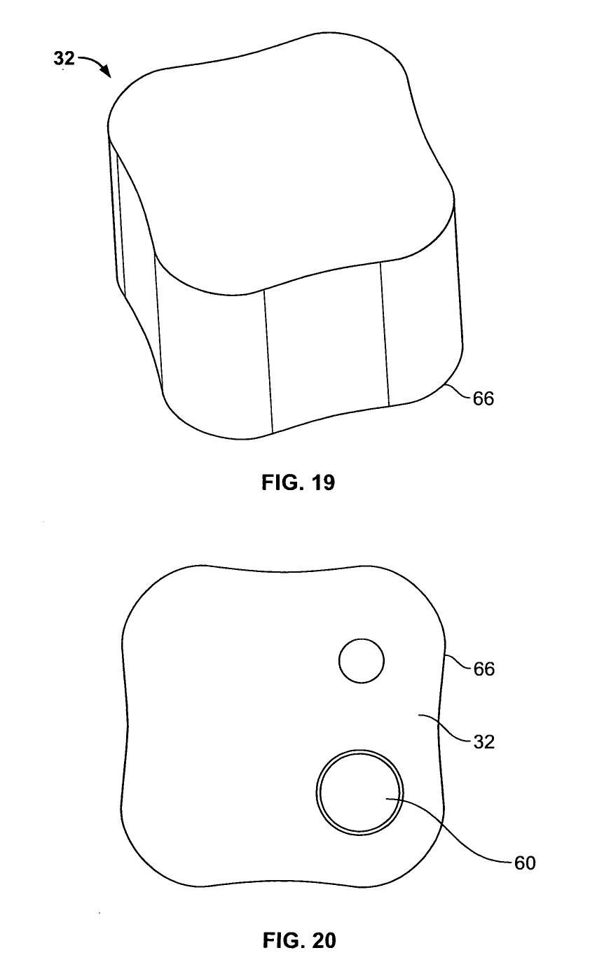

The battery 32 is preferably a rechargeable power source. In one form, the battery 32 may be directly electrically connected with an external power source, such as a charging base (not shown). In another form, the battery 32 may be inductively charged via a coil (not shown) that is preferably located below a bottom side 50 of the support base 30 (see FIG. 16) and a support cover 52 (see FIGS. 9 and 15). That is, FIG. 15 shows the support base 30 with the support cover 52 secured thereon, while FIG. 16 shows the bottom side 50 of the support base 30 without the support cover 52. A space 53 (FIG. 15) is defined between the support base bottom side 50 and the support cover 52 in which an induction coil, for instance, may be located. As shown in FIG. 15, the support cover 52 includes a connection port 54 that allows electrical contacts (not shown) to extend into and through the support base 30 so that the electrical contacts can be connected to battery terminals 60 (see FIGS. 7 and 20).

The base support 30 includes upstanding restraining portions 62 within which the battery 32 is received. Preferably, these restraining portions 62 are in the form of walls having a right angle therein so as to form a restraining corner 64 that closely receives a corner 66 of the battery 32.

In assembly, the external diffuser 12 is secured with the lighting device 10, which is itself first assembled. The lighting device 10 may be provided as an assembled device to a user or consumer, or may be provided as a kit that allows a consumer to custom select from a variety of interchangeable components.

For the lighting device 10, the support base 30 and support cover 52 are preferably provided as a single component. The battery 32 is then inserted into the restraining walls 62 with its terminals 60 properly aligned with the restraining portions 62 in the support base 30 that allow access for recharging through the connection ports 54, if so equipped.

Next, the circuit module 34 is placed or secured on top of the battery 32. The circuit module preferably includes a circuit board 100, one or more light emitters 102, and one or more electrical connectors 104. When the circuit module 34 is thus located, the electrical connector extends from the circuit board 100 and downwardly alongside the battery 32. A lower portion 10 thereon is electrically connected to the battery 32, while an upper portion 112 connects to the circuit board 100 to allow power from the battery 32 to power the circuit board 10 and light emitters 102. It should be noted that, in another form, the circuit board 100 itself may rest on battery contacts (not shown) on a top surface thereof and, thus, be directly connected electrically with the battery/power source 32.

The internal diffuser module 36 is then secured on top of and over the circuit module 34 and the battery 32. The internal diffuser 36 performs a number of functions. First the internal diffuser 36 conditions light from the light emitters 102. Additionally, the internal diffuser 36 secures with the support base 30 to secure the components of the lighting device 10 in their proper positions. As an extension of this, the internal diffuser 36 is easily removed to allow, for instance, a user to selectively change or replace the components.

The internal diffuser 36 includes at least a top portion 120 formed of material similar or identical to that of the external diffuser 12, discussed above. The top portion 120, as shown, has a dome or half-sphere portion on its outer surface 120a. This dome portion 120 has a similar interior shape so as to define a recess 122 within which the light emitters 102 are positioned when the lighting device 10 is assembled.

Below the top dome portion 120 is an intermediate portion 140 forming a shoulder 121 at the recess 122 with an interior cavity 124 of the internal diffuser 36. When the lighting device 10 is assembled, the circuit module 34 and the battery 32 are substantially located within this interior cavity 124.

The shoulder 121 is surrounded by an intermediate portion wall 126 extending downwardly therefrom. The shoulder 121 also includes a downward facing surface 128 with a plurality of registration pins 130. When assembled, the circuit board 100 is located proximate the shoulder surface 128 and within the intermediate portion wall 126. The registration pins 130 cooperate with and are received by registration openings 132 formed in the circuit board 100, as shown in FIGS. 10 and 27. If desired, the registration pins 130 may be heat staked or deformed after passing through the circuit board 100 so that, together, the circuit board 100 and internal diffuser 36 may be handled, assembled, or replaced as a single unit.

The internal diffuser intermediate portion 140 is joined with a lower portion 150 of the internal diffuser 36. The lower portion 150 includes an outwardly extending portion 150a that includes registration or securing structure 153 that cooperates and engages with the lower portion 110 of the electrical connectors 104. When the circuit module 34 within the internal diffuser 36 is secured with the support base 30, the securing structure 153 provides proper positioning and location of the electrical connecter lower portion 110 for electrical communication with the battery 32.

The lower portion 150 of the internal diffuser 36 that is shaped similarly to the intermediate portion 140. More specifically, the internal diffuser 36 is, other than the top dome portion 120 and outwardly extending portion 150a, generally square or rectangular. As such, the lower portion 150 includes a pair of generally flat securing tabs 152 for releasably securing the internal diffuser 36 with the support base 30.

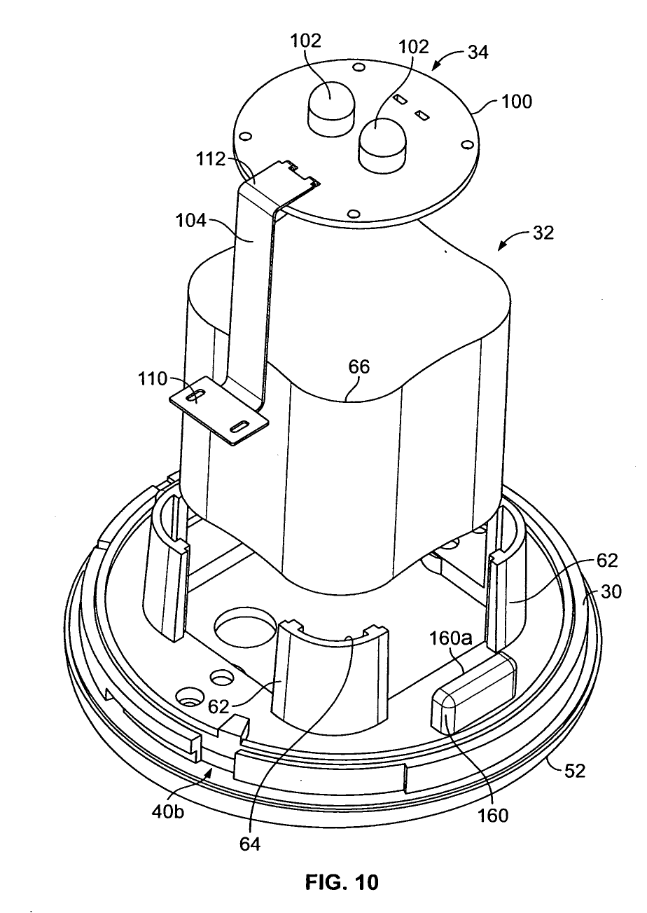

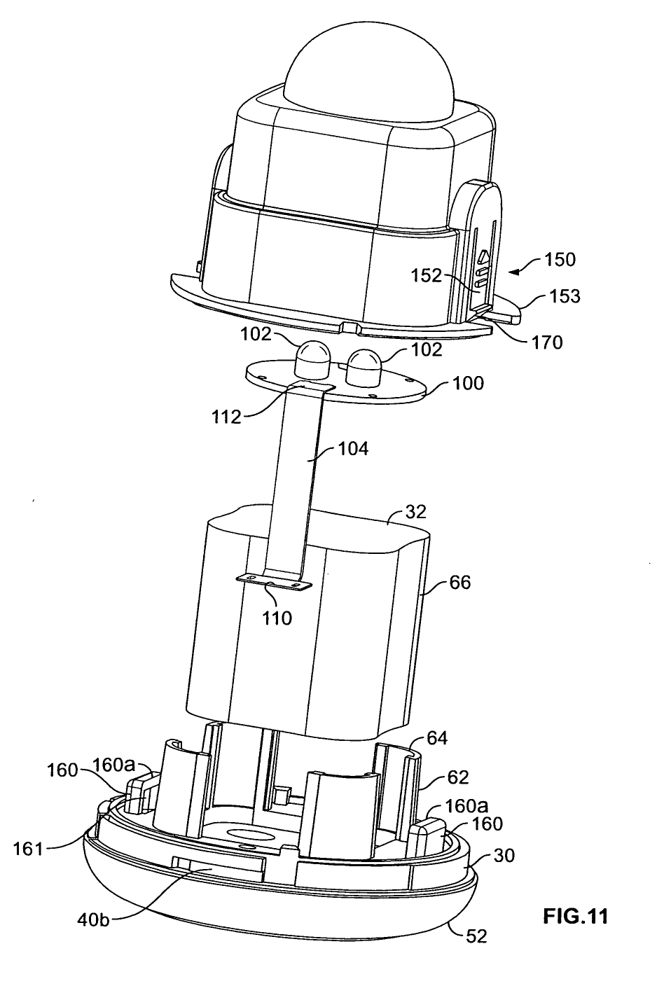

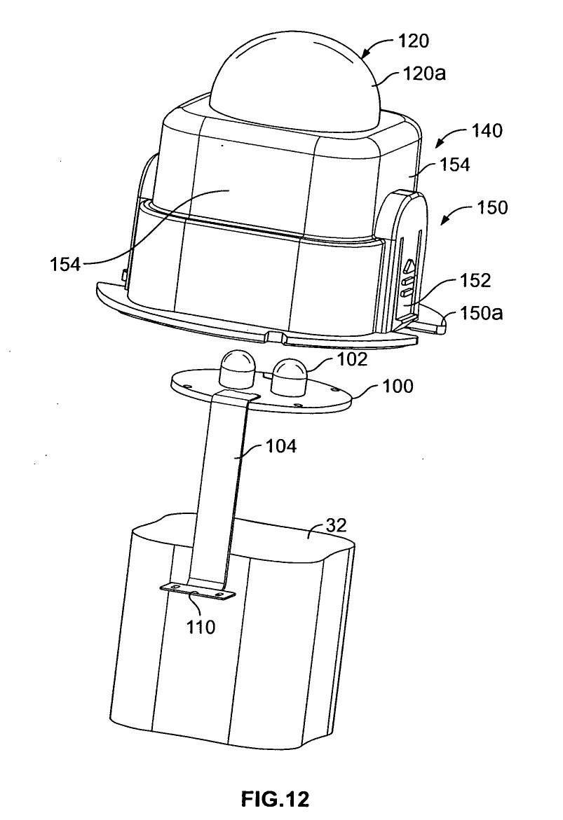

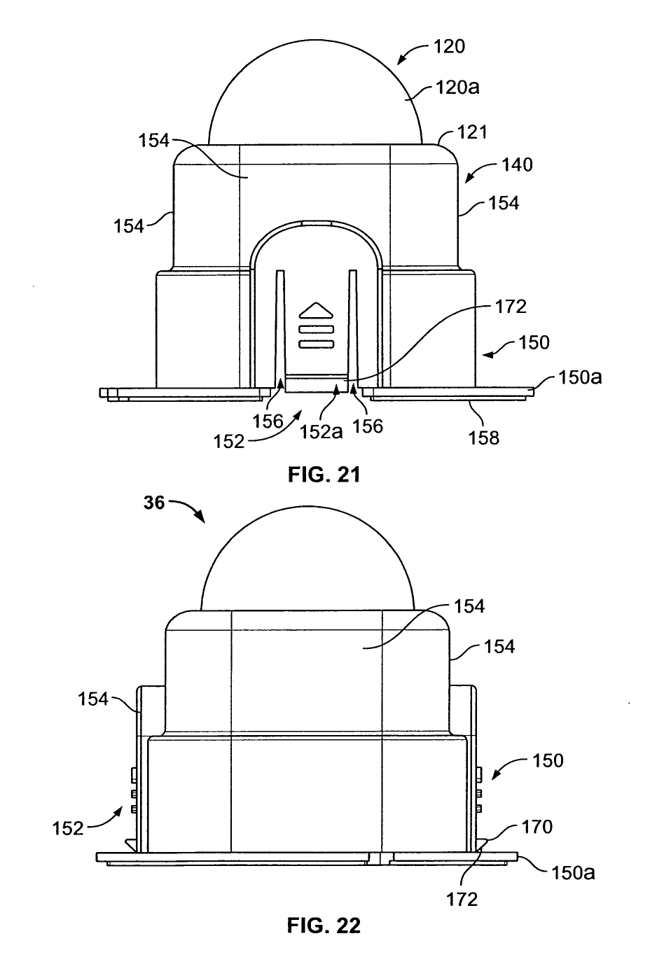

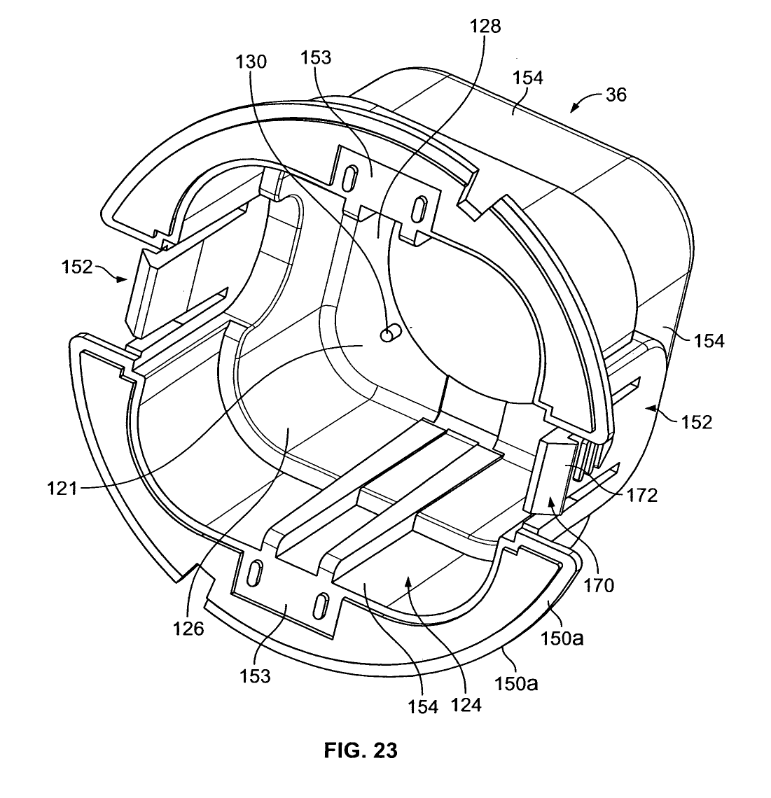

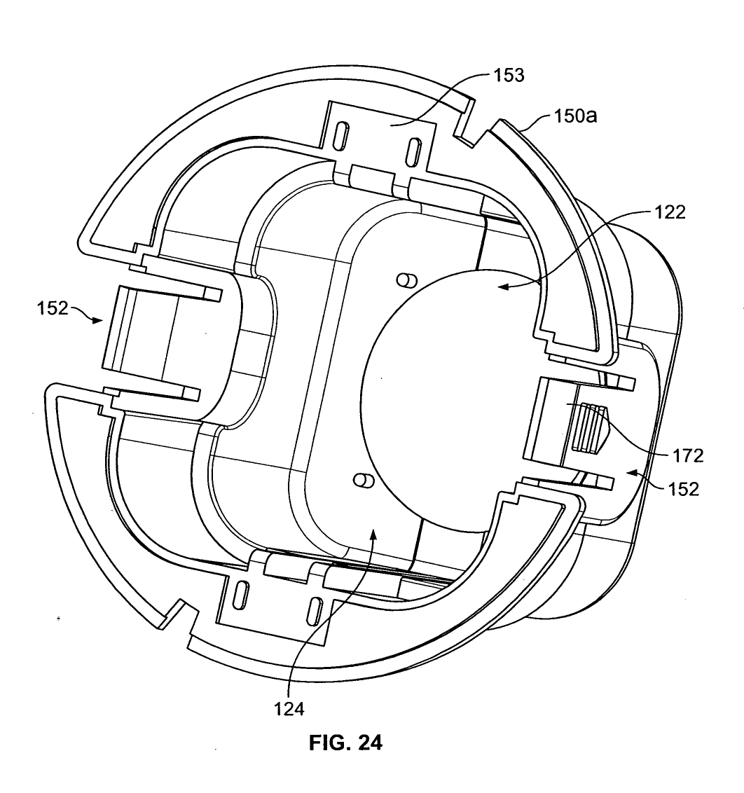

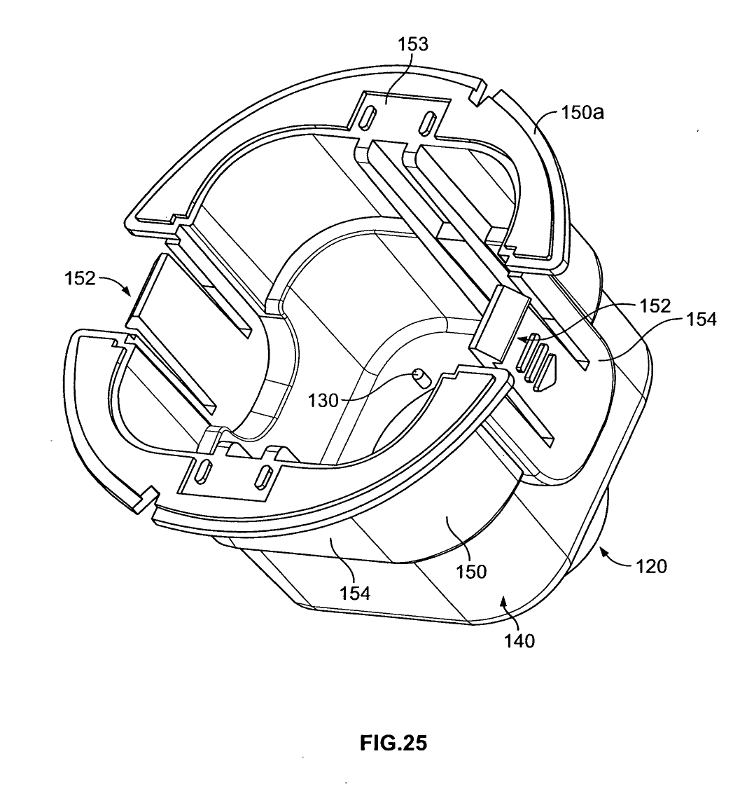

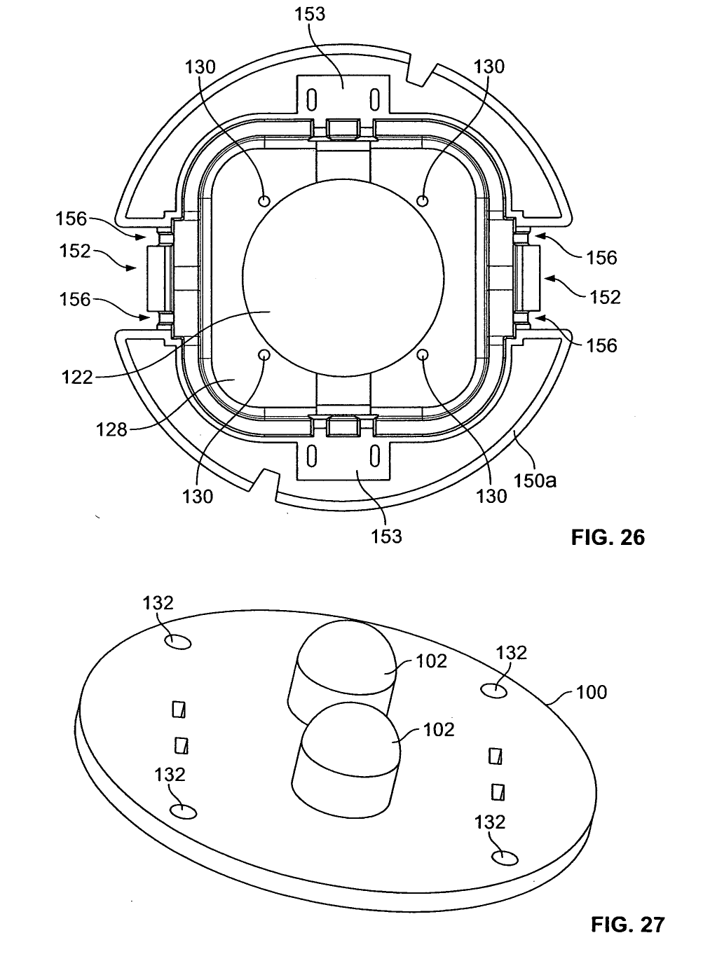

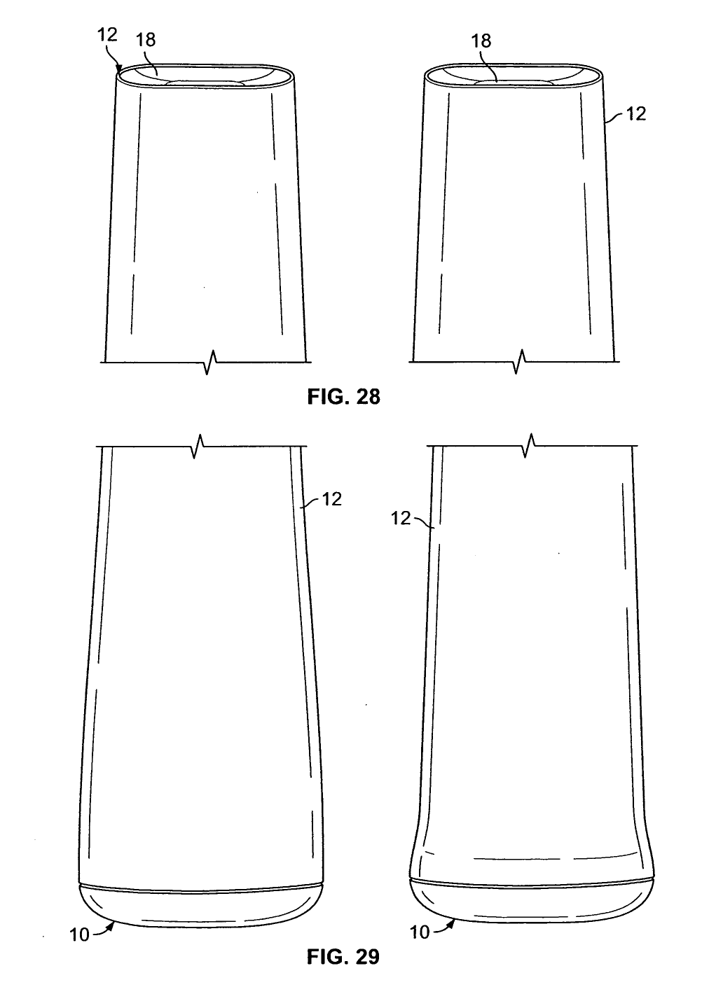

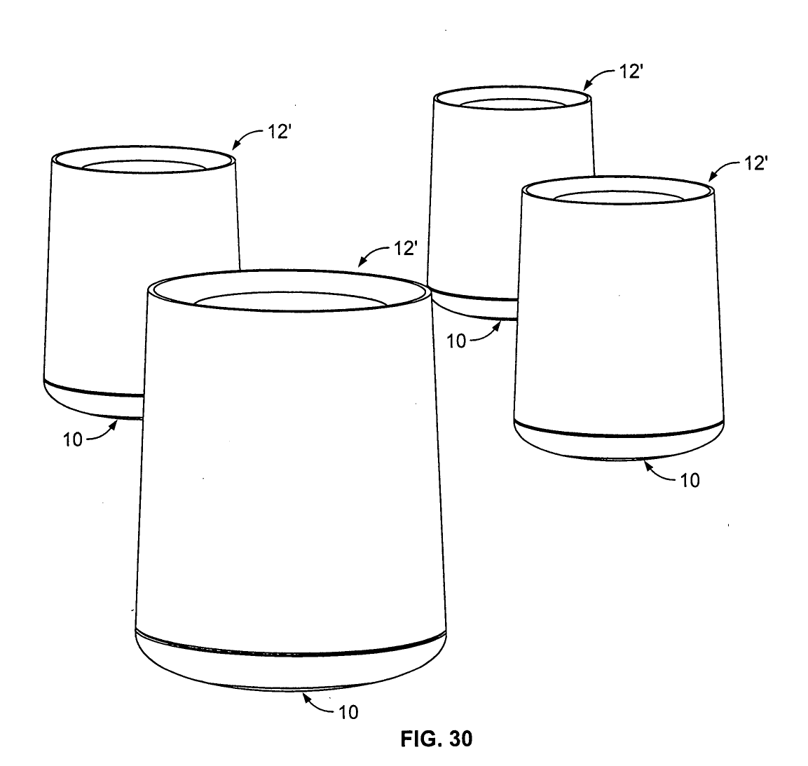

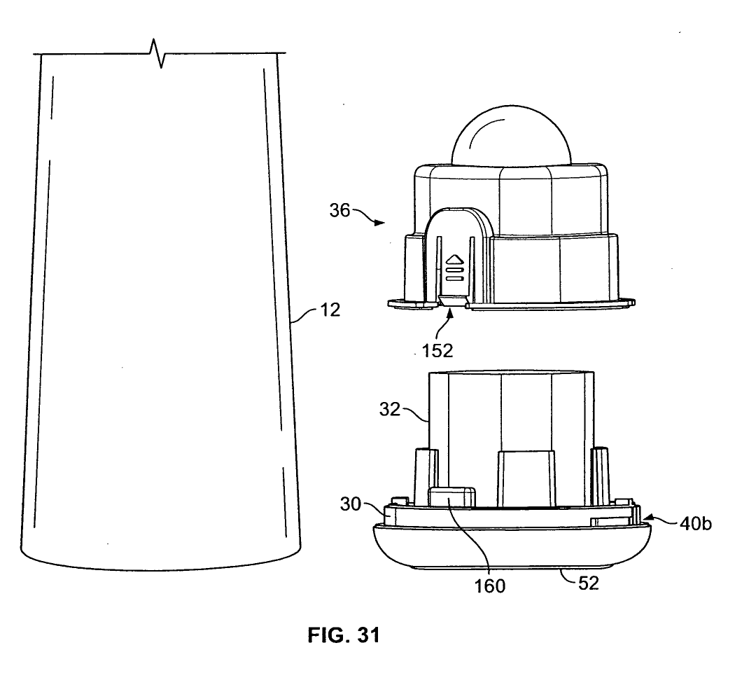

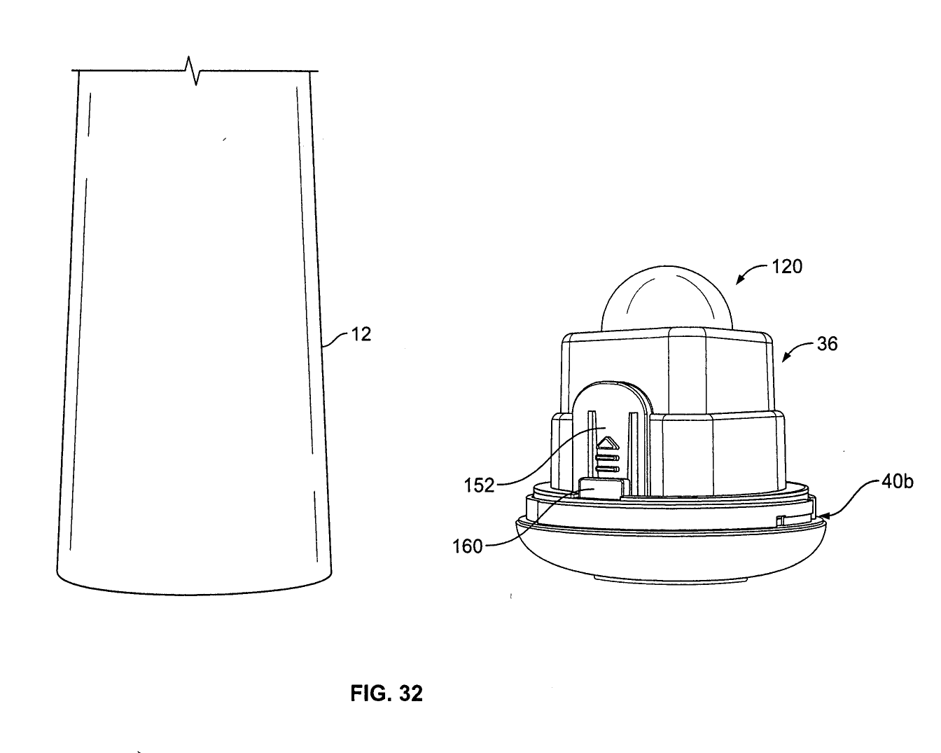

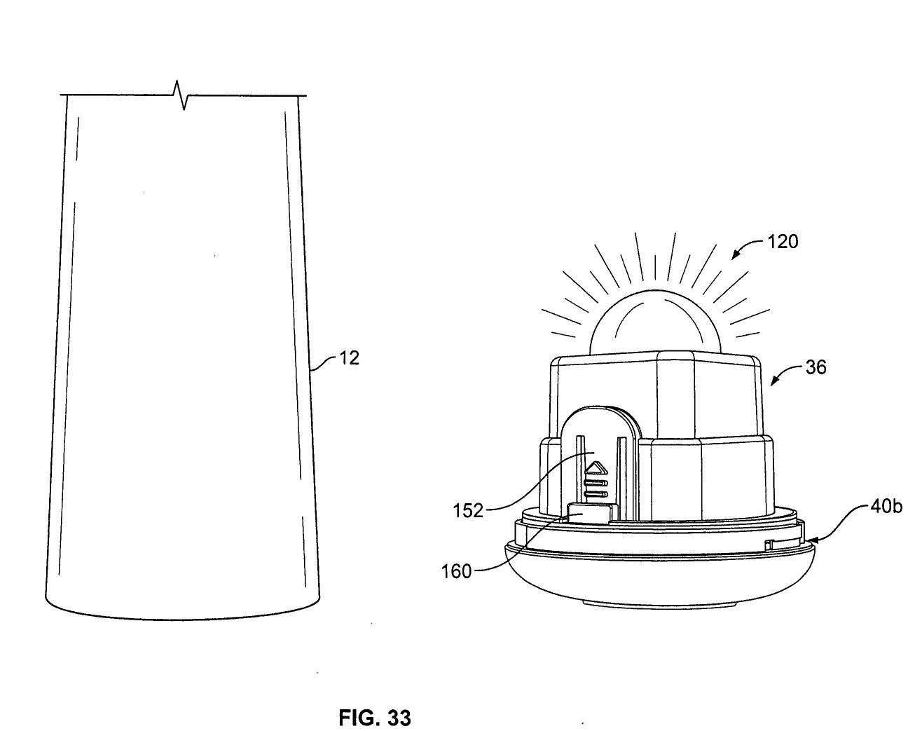

In greater detail, the lower portion 150 has, in the present form, generally four sides 154, one or more of which include a securing tab 152. The tab 152, shown best in FIG. 21, is formed by a pair of parallel slots 156 extending upwardly from a point proximate a bottom 158 of the lower portion 150. The slots 156 serve to define the sides of the tab 152, which has a terminal portion 152a extending downwardly to an extent sufficient to allow a portion thereof to be engage with the support base 30. The support base 30 includes engagement tabs 160 having recesses 161 (or, alternatively, simply recesses) for this purpose, best seen in FIGS. 10 and 11.

The terminal portion 152a include a prong or barb 170 with a chamfer or wedge surface 172 thereon. As the internal diffuser 36 with the tabs 152 is advanced towards the support base 30 with the engagement tabs 160, the chamfer 172 contacts an edge 160a of the engagement tab 160 or openings. With continued advancement, the chamfer 172 causes the tab 152 to deflect inwardly relative to the sides 154 of the lower portion 150. Once sufficiently downwardly, the barb 170 becomes aligned with the recesses formed in the engagement tabs 160 of the support base 30. After this point, the tabs 152 resiliently shift outward so that the barb 170 is in an interference position with the interior of the engagement tab recess, and the internal diffuser 36 is secured therewith. In this manner, the circuit module 34 and battery 32 are also secured. To release the internal diffuser 36 from the support base 30, a user merely presses inwardly on the tabs 152 so that the barbs 170 are resiliently shifted out of the recesses in the engagement tabs 160, internal diffuser is then lifted away from the support base 30.

As noted above, the circuit module 34 includes light emitters 102. Preferably, these are in the form of light emitting diodes, or LEDs. Also noted above is that the internal diffuser 36 conditions the light from the light emitters 102. Some LEDs have particular inherent color characteristics which are undesirable. For instance, LEDs may have a color tint that is undesirable (such as a light green or pink hue). In some instances, LEDs may be “too white,” meaning that the light is harsh in comparison with traditional incandescent bulbs or the color of a flame of a burning candle. Selection of color and material of the internal diffuser 36 (as well as external diffuser 12) can be made in order to select a desired color to be emitted from the lighting device 10 (and external diffuser 12), include non-white colors such as colors associated with a particular holiday.

Because of the construction of the lighting device 10, the circuit module 34 may easily be changed. While it may be desirable or necessary to simply change the LEDs 102 from the circuit board 100, it may also be desirable to selectively change the entire circuit module 34. For instance, the circuit module 34 carries a microchip (such as integrated circuit) that controls the lighting of the light emitters 102. The microchip is typically statically pre-programmed to allow for constant lighting. However, one may use the microchip to control the lighting for a variety of effects, such as alternating between two differently colored LEDs or by having the LEDs flash in a pre-programmed sequence. By allowing a user to select a circuit module 34, the desired effect can be selected, such as if the lighting device 10 were provided as a kit or marketed as having available interchangeable components. Furthermore, this would allow a manufacture to keep interchangeable components on hand for a variety of forms of the lighting device 10, most of the components being uniform while simply making a selection from a plurality of various circuit modules 34 for the assembly of a particular lighting device 10. It should be recognized that these features are equally applicable to the other components of the lighting device 10, including the battery 32 and the internal diffuser 36. It should also be recognized that various external diffusers 12 may be provided for use with the lighting device 10.

While the invention has been described with respect to specific examples including presently preferred modes of carrying out the invention, those skilled in the art will appreciate that there are numerous variations and permutations of the above described systems and techniques that fall within the spirit and scope of the invention as embodied in the following claims.

1. A modular assembly for a lighting apparatus, the assembly comprising:
a battery module;
a base module having receiving structure for retaining the battery module;
a lighting module positioned proximate the battery module;
a cover module; and
securing structure for releasably securing the base module and the base module.

2. The assembly of claim 1 wherein the battery module is closely received within the base module receiving structure.

3. The assembly of claim 1 wherein the securing structure is a quick-connect structure.

4. The assembly of claim 3 wherein the quick-connect structure is released and secured via a turn of 90 degrees or less.

5. The assembly of claim 1 wherein the lighting module includes releasably secured lighting elements.

6. The assembly of claim 1 wherein the lighting module includes a circuit board, and the lighting module is substantially immobilized in the assembly.

7. The assembly of claim 6 wherein the lighting module includes registration structure for substantially immobilizing the lighting module in the assembly.

8. The assembly of claim 1 further including an internal diffuser releasably secured in the assembly.

9. The assembly of claim 8 further wherein the internal diffuser and base module include cooperating engagement structures for releasably securing the internal diffuser with the base module.

10. The assembly of claim 1 wherein the cover is an external diffuser.

11. The assembly of claim 1 wherein the lighting module and battery module have respective electrical terminals, and, in the assembly, the lighting module terminals are positioned against the battery module terminals.

12. A kit for assembling at least a first lighting apparatus, the kit comprising:
at least one battery module;
at least one base module having receiving structure for retaining a battery module, and having a first portion of securing structure;
at least one lighting module positionable proximate the battery module in an assembled lighting apparatus;
at least one cover module having a second portion of securing structure, wherein the first and second portions of securing structure permit the cover module and base module to be releasably secured.

13. The kit of claim 12 including a plurality of lighting elements, each lighting element being selectively releasably securable with each lighting module.

14. The kit of claim 13 wherein at least two of the lighting elements have a different color.

15. The kit of claim 12 including a plurality of lighting modules, each lighting module being selectively assembled with a lighting apparatus.

16. The kit of claim 14 wherein each of the lighting modules includes a circuit board, and at least two of the circuit boards provide different lighting effects when assembled with a lighting apparatus.

17. The kit of claim 12 including a plurality of cover modules, each cover module being selectively assembled with a lighting apparatus.

18. The kit of claim 17 wherein at least two of the cover modules have respective different colors.

19. The kit of claim 18 wherein at least two of the cover modules have respective different shapes.

20. The kit of claim 12 wherein each cover module is an external diffuser.

21. The kit of claim 12 further including at least one internal diffuser releasably secured in the assembly.

22. The kit of claim 21 wherein each base module and each internal diffuser include respective cooperating engagement structures for selectively releasably securing the internal diffuser with the base module.

23. A method of assembling a lighting apparatus, the method comprising:
providing a base module;
securing a battery module within the base module;
selecting a lighting module;
positioning the lighting module on the battery module; and
releasably securing a cover module with the base module and over the lighting module and battery module.

24. The method of claim 23 further including the step of selecting the cover module from a plurality of cover modules, at least two of which have a different physical characteristic.

25. The method of claim 24 wherein the step of selecting the cover module includes selecting a physical characteristic from the group comprising color and shape.

26. The method of claim 23 wherein the step of selecting a lighting module includes selecting a light emitting characteristic from the group comprising color and pattern.

27. The method of claim 26 wherein the step of selecting a light emitting characteristic includes selecting light emitting elements.

28. The method of claim 23 further including the steps of:
positioning an internal diffuser over the lighting module and the battery module; and
releasably securing the internal diffuser with the base module.

29. The method of claim 28 further including the step of selecting the internal diffuser, the selecting being based on color of the internal diffuser.
